(19) United States
(12) Patent Application Publication
(10) Pub. No.: US 2006/0012678 A1
(43) Pub. Date: Jan. 19, 2006

(54) Method and system for forming an image of an organ

(76) Inventor: Markku Broas, Rovaniemi (FI)

Correspondence Address: OLIFF & BERRIDGE, PLC, P.O. BOX 19928, ALEXANDRIA, VA, 22320, US

(21) Appl. No.: 10/518,910

(22) PCT Filed: Jun. 24, 2003
(86) PCT No.: PCT/FI03/00513

§ 371 Date: Aug. 10, 2005

(30) Foreign Application Priority Data
Jun. 24, 2002 (FI) 20021233

(51) Int. Cl. H04N 7/18

(52) U.S. Cl. 348/77

(57) ABSTRACT

The invention relates to a method and system for forming an image of an organ. The solution comprises emitting optical radiation toward an organ via at least one exit aperture (412 to 414) of a camera unit (200) and, via an entrance aperture (406) of the camera unit, forming an image of the organ by means of the optical radiation supplied from the organ, and emitting and receiving the optical radiation via separate entrance aperture (406) and exit apertures (412 to 414) whose optical axes differ from each other.

### FIELD

The invention relates to a solution wherein an organ is illuminated by optical radiation and an image is formed of the illuminated organ.

### BACKGROUND

In the visual examination of organs, such as the eye, ear and skin, optical appliances can be utilized. Although illuminating the target under examination and forming an image play a very important role in the examination of all organs, this is particularly important while examining the eye. Optical devices for examining the eye must be able to illuminate the fundus of the eye in an appropriate manner and to form a clear image of the fundus of the eye through the pupil, whose diameter is of few millimetres only.

In the devices for examining the eye, the radiation of an optical radiation source is directed at a mirror, which is usually annular in shape. The optical radiation pattern which, annular in shape, is reflected from the mirror is directed at the pupil of the eye to be examined through a lens. The optical radiation reflecting back from the eye returns through the pupil along the same optical axis and exits the eye, passing through the centre of the annular mirror. A camera or an eye of the examining doctor forms an image utilizing the radiation returning from the eye under examination through the mirror.

Such a solution has several problems. Directing the radiation to the eye under examination by means of a mirror impairs the efficiency at which optical power is conveyed to the eye under examination from a radiation source, increases the size of the device and makes it more difficult to manufacture since aligning the optical parts with respect to each other requires accuracy. Furthermore, when examining the fundus of the eye, the optical radiation emitted to the eye is reflected from the surface of the eye to a camera or the doctor's eye, interfering with the measurement, although an attempt is made to alleviate the problem by means of the annular radiation pattern. Different factors thus impair the image obtained of the eye under examination.

### BRIEF DESCRIPTION

An object of the invention is to provide an improved method and a system implementing the method for enhancing and simplifying the process of forming of an image. This is achieved by a method for forming an image of an organ, the method comprising illuminating an organ by radiation emitted from a hand-held camera unit, and forming an image in an electronic form of the organ by means of a camera of the camera unit. The method further comprises emitting optical radiation toward the organ via at least one exit aperture of the camera unit and, via an entrance aperture of the camera unit, forming an image of the organ by means of the optical radiation supplied from the organ, and emitting and receiving the optical radiation via separate entrance aperture and exit apertures whose optical axes differ from each other.

The invention also relates to a system for forming an image of an organ, the system comprising at least one optical radiation source for illuminating an organ, and a hand-held camera unit comprising a camera for forming an image in an electronic form of an organ illuminated by at least one optical radiation source. The camera unit further comprises at least one exit aperture via which the radiation of the optical radiation source is emitted toward the organ, and at least one entrance aperture via which the optical radiation supplied from the organ is received by the camera unit, each exit aperture and entrance aperture being separate apertures with respect to each other whose optical axes differ from each other.

Preferred embodiments of the invention are disclosed in the dependent claims.

The idea underlying the invention is that an organ of which an image is to be formed is illuminated without using a mirror, and optical radiation is emitted and received using different axes.

The method and system of the invention provide several advantages. An organ to be examined can be subjected to radiation at good efficiency, the need for space required by the system is small, and aligning and manufacturing the optical parts become easier. Furthermore, harmful reflections are insignificant.

### LIST OF DRAWINGS

The invention is now described in closer detail in connection with the preferred embodiments and with reference to the accompanying drawings, in which

FIG. 1 shows an arrangement for examining an eye,

FIG. 2 shows an examination device having two axes,

FIG. 3 shows radiation patterns on the pupil of the eye of a system having two axes,

FIG. 4A shows a camera unit,

FIG. 4B shows a camera unit suitable for examining an ear,

FIG. 4C shows a nose part suitable for examining the surface of an organ,

FIG. 5 shows a camera unit and a power source unit, and

FIG. 6 is a block diagram of the system.

### DESCRIPTION OF EMBODIMENTS

The disclosed solution is particularly suitable for forming an image of an eye, but the disclosed solution may also be used for forming an image of an ear or the skin without, however, being restricted thereto.

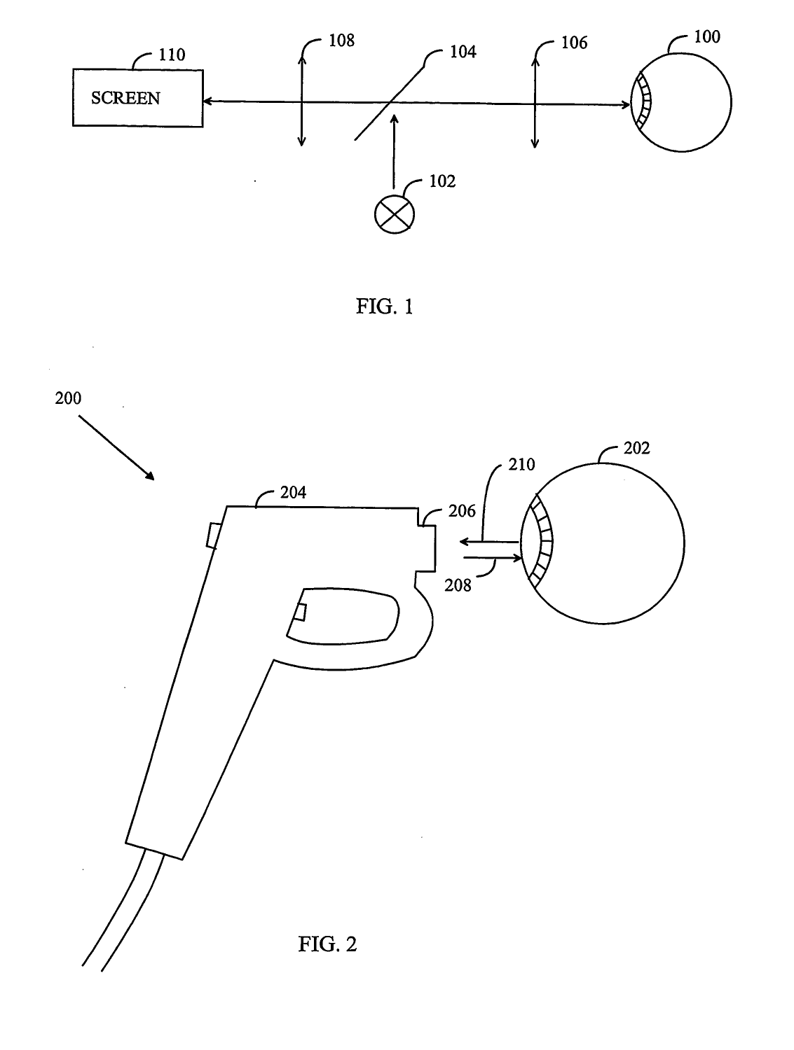

By means of FIG. 1, let us first view a prior art arrangement for examining an eye. Optical radiation is applied to an eye 100 from an optical radiation source 102 via an annular mirror 104 and a lens 106. The mirror 104 forms an annular radiation pattern, whose optical power is collected to the pupil of the eye 100 by means of the lens 106. Using the lens 106, radiation reflected from the fundus of the eye 100 is collected such that the radiation progresses via an aperture in the centre of the annular mirror 104 to a lens 108, which forms an image of the fundus of the eye 100 onto a screen 110, which may be a camera or an eye of the person examining the eye 100. The solution of FIG. 1 thus uses uniaxial optics, wherein the radiation of the optical radiation source is focused on the eye, returning from the eye along the same optical axis. Uniaxiality does, however, cause interfering reflections on the surface of the eye that, once formed, cannot be removed. Furthermore, directing the radiation to the eye under examination by means of a mirror increases the size of the device and makes it more difficult to manufacture.

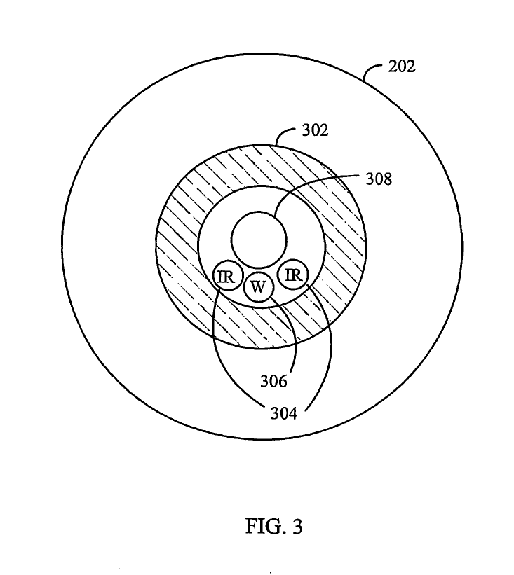

By means of FIGS. 2 and 3, let us now view a solution according to the disclosed solution, wherein the organ to be examined is an eye. According to the disclosed solution, optical radiation 208 emitted by a nose part 206 of a camera unit 200 progresses to the eye 202 under examination along an optical path different from that used by optical radiation 210 reflected back to the camera unit 200 from the eye 202.

FIG. 3 shows how optical radiation patterns are directed to an eye to be examined for examining the fundus of the eye. In the disclosed solution, the optical radiation used may be infrared radiation and visible light radiation. Both at least one radiation pattern 304 of the infrared radiation and at least one radiation pattern 306 of the visible light are directed to the pupil 302 of the eye to be examined. The optical radiation is directed at a point of the pupil different from the point from which the radiation returns to the camera unit. Thus, a detecting component does not detect areas illuminated by emitted radiations on the surface of the eye under examination. In the example of FIG. 3, two infrared radiation patterns 304 are directed at the perimeter of the pupil 302, the radiation pattern 306 of the visible light being directed therebetween. Usually, an eye can be illuminated such that infrared radiation is directed at the pupil of the eye symmetrically with respect to the radiation pattern of visible light. In addition, radiation directed at the eye can be collimated or focused onto the surface of the eye. The radiation reflected from the fundus of the eye 200 is received from the area of the pupil which receives no optical radiation from the camera unit. This area, which is designated by reference number 308, may reside in the middle of the eye, or otherwise separately from the optical radiation directed at the eye.

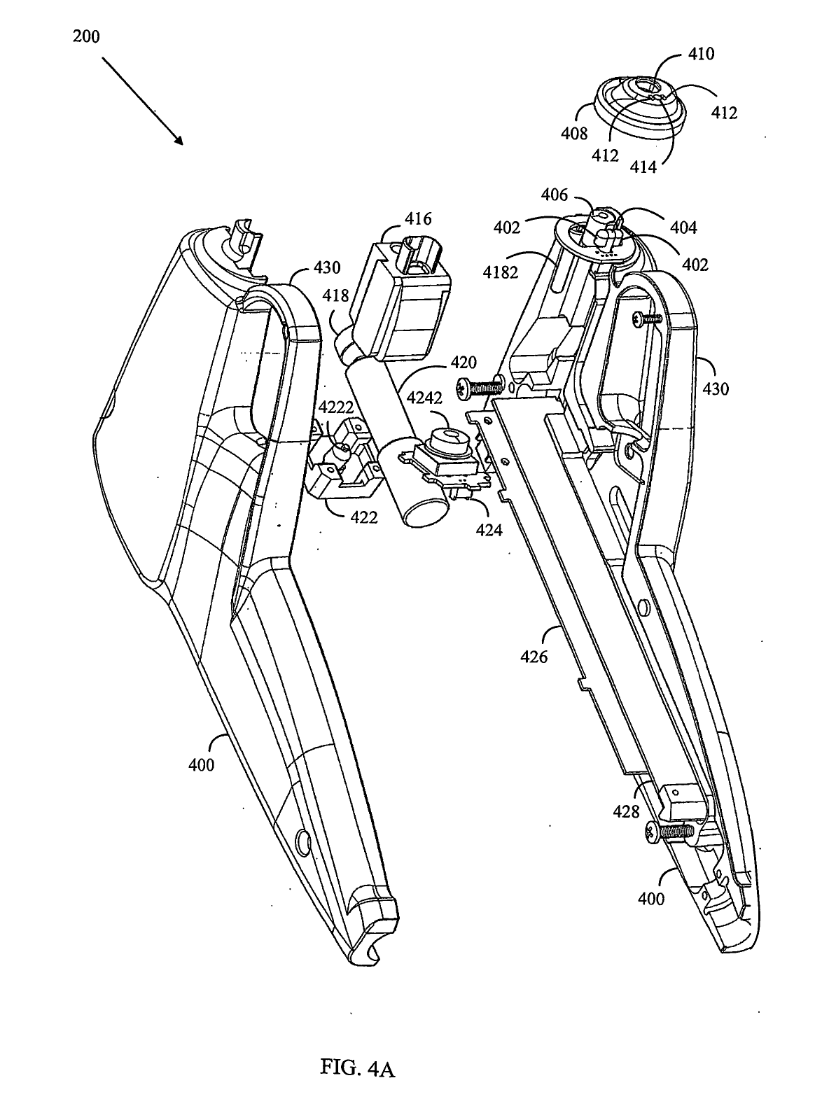

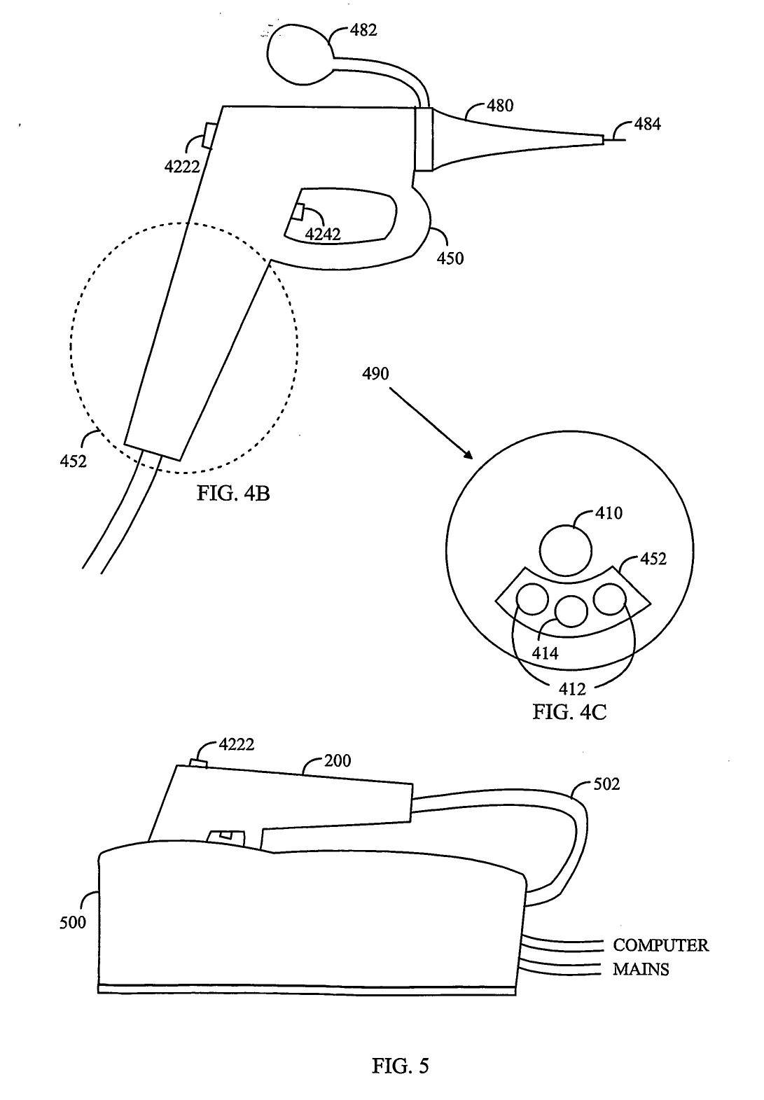

Let us now view a camera unit according to FIG. 4A for examining the fundus of the eye. For the most parts, the camera unit and the entire system are the same as in the solution disclosed in PCT application WO 00/71021 and the corresponding Finnish patent FI 107120; therefore, the present application does not disclose all features known per se of the camera unit and the system in closer detail but expressly concentrates on the features of the disclosed solution that differ from the prior art. A camera unit which in its external appearance resembles a pistol may, according to FIG. 4A, comprise two frame parts having fastening points required by different components and pivoting surfaces for movable mechanics dimensioned therein. The material of the frame 400 is irrelevant to the disclosed solution; however, the cover may be made e.g. of plastics or metal. The frame parts, which operate as the covers of the camera unit, may be fastened to each other by screws. The shape and dimensions of the camera unit are hand-fitting, so both the shape and the dimensions are unique, enabling accurately determined illumination distributions on the target of which an image is to be formed.

The camera unit may comprise three optical radiation sources 402 to 404, of which the radiation sources 402 are infrared sources while the source 404 is a source of visible light. The visible light source 404 emits narrowband visible radiation (‘monochromatic light’), or the source may be a source emitting broadband visible radiation, i.e. a ‘white light source’. The optical radiation sources 402 to 404 may be semiconductor emitters, such as leds (Light Emitting Diode). The camera unit requires at least one optical radiation source, which may be either an infrared source or a visible light source. Usually, both a visible light radiation source and an infrared source constitute the optical radiation sources of a camera unit. Infrared radiation may be used for examining an eye without using eyedrops to enlarge the pupils since the pupil does not react to infrared radiation. Infrared radiation enables a black-and-white image of the eye to be obtained, but visible light used in flashes or as continuous light also enables a colour image of the eye to be obtained.

Parallel but having a different axis, an optical component 406 comprising at least one lens is provided next to the optical radiation sources. The optical component 406 is used for receiving optical radiation reflected from an organ and for forming an image of the organ for a detecting component 416. The components 406 and 416 constitute the camera of the camera unit. The detecting component 416 may be a video camera comprising a CCD cell (Charge Coupled Device), which forms a continuous video image of the target to be examined. A commercially available video camera is very suitable for the purpose. A black-and-white camera is possible, but a colour camera provides substantially more information on the target under examination.

The camera unit 200 may also comprise a nose part 408 suitable for examining an eye, the nose part including an entrance aperture 410 for receiving radiation by an optical component 406, and exit apertures 412 to 414 separate from the entrance aperture, for each optical radiation source. The nose part 408 corresponds to the nose part 206 in FIG. 2. With no nose part 408, the entrance aperture 410 is determined by an aperture connected to the optical component 406 while internal apertures of the optical radiation sources operate as exit apertures 412 to 414, which also define the angular aperture of radiation. While forming an image of an organ, the nose part is brought close to the particular organ, usually at a distance of few millimetres or dozens of millimetres from the organ of which an image is to be formed. The optical axes of the exit aperture and the entrance aperture are parallel and unidirectional. Different nose parts are provided for different examination purposes.

The optical radiation sources 402 to 404 may also be positioned further inside in the camera unit 200 or even in a power source unit, using optical fibres (not shown in the figures) to conduct radiation from the radiation sources such that optical radiation can be directed at the organ under examination by the side of the optical component 406. In such a case, ends of the optical fibres reside in place of the optical radiation sources 402 to 404. The ends of the optical fibres may be provided with focusing or collimating lenses in order to direct a radiation pattern at the organ of which an image is to be formed. The exit aperture is then determined by the numerical aperture of a fibre (affected by a possible lens) or the aperture of a nose part.

The camera unit is optically focused using an eccentric ring 418 and a motor 420 to rotate the eccentric ring. A user may control the rotation of the eccentric ring 418 by the motor 420 by means of a pin controller arrangement 422, which is generally used for making different functional selections. The eccentric ring 418 is used for moving the detecting component 416 back and forth such that a spring 4182 presses the detecting component 416 continuously against the eccentric ring 418, and when the eccentric ring rotates, the detecting component being pressed against the perimeter of the eccentric ring 418 moves back and forth, pushed by the eccentric ring and returned by the spring, on a slide part belonging to the detecting component 416 pivotally mounted on the frame parts. When the distance between the detecting component 416 and the optical component 406 changes due to the back-and-forth movement, the detecting component 416 may be provided with an image of targets at different distances. The movement of the detecting component 416 obtained by means of the eccentric ring 418 is thus used for changing the focal point of the camera unit 200.

The camera unit comprises printed circuit boards 426 and 428, of which the circuit board 426 is a processor circuit board while the circuit board 428 is a camera circuit board. The processor circuit board 426 is responsible for managing the control and user interface of the device while the camera circuit board 428 produces a video signal from a signal supplied from a CCD cell.

An index finger trigger 4242 of a trigger structure 424 and a four-way pin controller 4222 of the pin controller structure 422 to be used by the thumb constitute the user interface of the camera unit.

The camera unit is started by pressing the trigger 4242. If the camera unit has not been used for about five minutes, it will be switched off automatically. This is of particular importance when a battery is used.

In the horizontal directions, the pin controller 4222 is provided with a uniplanar function for adjusting visible light. By turning the pin controller 4222 to the right, the intensity of visible light increases, and by turning the pin controller to the left, the intensity of visible light decreases. The range of adjustment may be provided e.g. with 7 steps such that after start-up the adjustment resides in a value of 4.

The illumination to be used for illuminating the organ to be examined is selected by moving the pin controller 4222 upward. Upon start-up, the camera unit may have infrared illumination as a default. The illumination of visible light can be selected by pushing the pin controller 4222 upward. A single image is formed of the target under examination by pushing the pin controller 4222 down, in which case the camera unit also transmits an image capture signal to a data processing device. An image produced by the camera unit is focused by moving the pin controller 4222 downward. Focusing is carried out e.g. by keeping the pin controller 4222 down for a long time, so that the focusing changes continuously since the eccentric ring moves the detecting component back and forth. The pin controller may also be momentarily pressed in series of short presses to change the focusing stepwise in small steps. When the desired focusing is found, the pressing of the pin controller 4222 may be stopped. When viewing a continuous video image, the trigger 4242 may be pressed, in which case the visible light radiation source flashes brightly and image capture is carried out. The camera unit 200 also comprises a cheek support 450 to be pressed against the cheek of the person to be examined when examining an eye. This reduces jitter and trembling. When examining the eye, the camera unit is located at about a 2 to 5 mm distance from the eye.

The disclosed solution is not restricted to examining an eye exclusively, but the solution may be used for examining an ear and the skin as well. FIG. 4B shows a camera unit whose nose part 480 is arranged for examining an ear. An ear funnel of the nose part forms a long tubular part, so that optical radiation supplied from an exit aperture collides with the edge of the tubular part, progressing, reflected from the walls of the funnel, all the way to an end of the tube. From the end of the nose part, which operates both as an exit and entrance aperture 410 to 414, the optical radiation directed at the area of which an image is to be formed is dispersed so that it has an even power distribution. The optical radiation can be dispersed or scattered also using a separate scattering optical component in the nose part. The nose part 480 may also comprise a pumping element 482 for pumping air into the ear via the nose part 480. The nose part 480 may further comprise a needle 484 for puncturing the eardrum. A handle of the camera unit 200 by which the camera unit is held in hand is designated by reference number 452.

FIG. 4C shows a nose part 490 of the camera unit, arranged for examining the surface of the skin or another organ. At the exit apertures 412 to 414, the nose part 490 then comprises an optical component 492 scattering optical radiation, the optical component spreading the optical radiation over a large area on the skin such that the optical radiation reflected from the skin or the surface of the eye may also be directed at the detecting component of the camera unit through the entrance aperture 410. In surface examinations the camera unit resides at about a 30 mm distance from the target under examination.

FIG. 5 shows the camera unit 200 and a power source unit 500 of a system for forming an image of an organ. The power source unit 500 is connected to the mains, the power source unit 500 converting the electric power it has taken from the mains into a form required by the camera unit 200. Between the camera unit 200 and the power source unit there is provided a cable 502 along which the power source unit 500 feeds the camera unit 200 the electric power it requires. Furthermore, the power source unit 500 is designed to allow the camera unit 200 to be firmly placed in its place on the power source unit 500 when the camera unit 200 is not used for examining an organ. The power source unit is heavy enough to stay on a table firmly. Furthermore, the power source unit 500 may comprise a battery, so that the power source unit does not have to be continuously connected to the mains even if the camera unit 200 were used for forming an image of an organ.

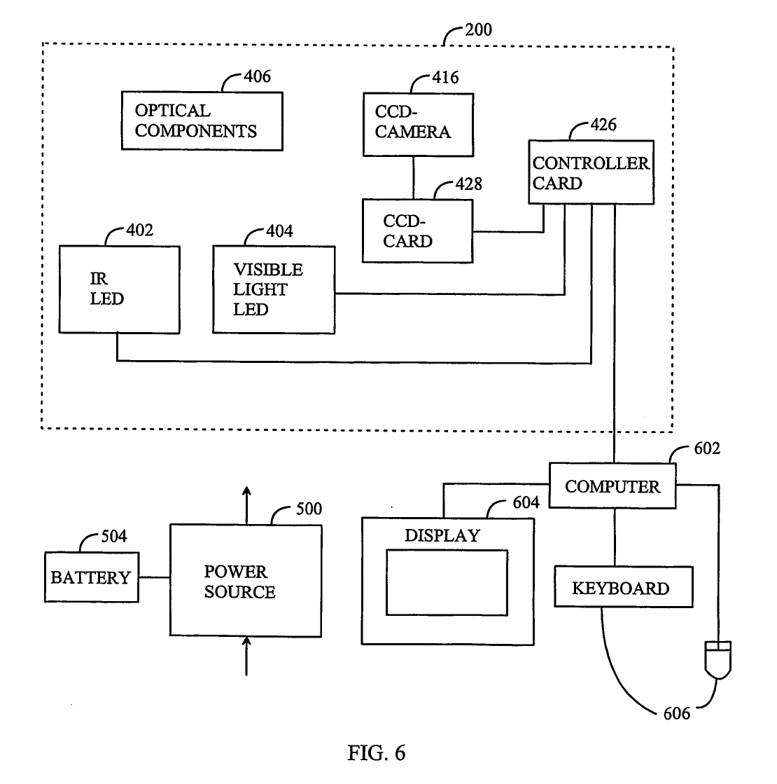

Let us further view the disclosed solution by means of FIG. 6. The camera unit 200 comprises an infrared radiation source 402, a visible light radiation source 404, an optical component 406 associated with a detecting component, a detecting component 416, a processor card 426, and a camera card 428. The processor card 426 controls the camera card 428. Image information is transferred from the detecting component 416 to the camera card 428, from which the image information is transferred to the processor card for preliminary image processing for converting the image information into e.g. a video signal. Such a video signal may be transferred to a data processing device 600, which may be e.g. a PC (Personal Computer). The data processing device 600 comprises a central processing unit 602 including an image processing program, a display 604 for visually displaying a view detected by the detecting component and a still image processed by the image processing program or a continuous video image, and a user interface 606, which may include a keyboard and a mouse for controlling the data processing device 600. Since it is most convenient to process a video signal in a digital form, either the camera unit or the data processing device converts the video signal generated by the camera card into a digital one. Image modifications, such as colour saturation or illumination adjustments, for making a diagnosis easier to achieve may be performed directly in connection with forming the image, and the process can be monitored from the display of the data processing device during the examination.

The data processing device 600 also enables a single image to be formed using image capture, when the person examining the organ under examination presses the trigger 4242. The captured still image can then be displayed on the display 606 of the data processing device and viewed in closer detail. The image to be viewed may also be stored in the memory of the data processing device. A continuous video image may also be stored in the memory of the data processing device. The memory may comprise e.g. a RAM memory (Random Access Memory) and a ROM memory (Read Only Memory), a hard disk, a CD (Compact Disc) or corresponding memory means known per se. The data processing device 600 is connected to the mains and/or it receives its electric power from a battery. The data processing means 600 may be connected to a data network, such as the Internet, via which image material formed by the camera unit 200 can be transferred to a desired place e.g. as email for distance consultation. Furthermore, a client register and a patient-specific filing system enable the produced image material to be kept in a logical order. The data processing device may also be provided with a case file to facilitate diagnostics and comparison between images.

The power source unit 500, which may comprise a battery, is responsible for the electric power of the camera unit. The power source unit 500 is connected to the mains.

Although the invention has been described above with reference to the example according to the accompanying drawings, it is obvious that the invention is not related thereto but can be modified in many ways within the scope of the inventive idea disclosed in the claims.

1. A method for forming an image of an organ, the method comprising illuminating an organ by radiation emitted from a hand-held camera unit (200), and forming an image in an electronic form of the organ by means of a camera (406, 416) of the camera unit, characterized by
emitting optical radiation toward the organ via at least one exit aperture (412 to 414) of the camera unit (200) and, via an entrance aperture (406) of the camera unit, forming an image of the organ by means of the optical radiation supplied from the organ, and emitting and receiving the optical radiation via separate entrance aperture (406) and exit apertures (412 to 414) whose optical axes differ from each other.

2. A method as claimed in claim 1, characterized in that the optical axes of the exit aperture (412 to 414) and the entrance aperture (406) are parallel and unidirectional.

3. A method as claimed in claim 1, characterized in that the camera unit (200) comprises a nose part (408, 480, 490) which, while forming an image of the organ, is brought close to the organ of which an image is to be formed, the nose part (408, 480, 490) comprising at least one exit aperture (412 to 414) and entrance aperture (406).

4. A method as claimed in claim 1, characterized by the organ of which an image is to be formed being an eye (202), whereby the optical radiation is directed only at a portion of the pupil (302) in accordance with the optical axis of the exit aperture (412 to 414); and forming an image of the eye over the portion (308) of the pupil (302) at which no optical radiation is directed, according to the optical radiation of the entrance aperture (406).

5. A method as claimed in claim 4, characterized by the optical radiation being infrared radiation and visible light radiation; illuminating the eye such that a radiation pattern (304) of the infrared radiation is directed at the pupil (302) of the eye symmetrically with respect to a radiation pattern (306) of the visible light.

6. A method as claimed in claim 4, characterized by focusing the optical radiation onto the surface of the eye.

7. A method as claimed in claim 1, characterized by the organ of which an image is to be formed being an ear, whereby the camera unit (200) uses a nose part (480) suitable for examining the ear;
dispersing, using the nose part (480) suitable for examining the ear, the optical radiation directed at the area of which an image is to be formed such that the optical radiation has an even power distribution.

8. A method as claimed in claim 1, characterized in that the organ of which an image is to be formed is skin, whereby the optical radiation is directed at the area of which an image is to be formed.

9. A method as claimed in claim 1, characterized in that the camera unit (200) and a power source unit (500) are interconnected by a cable (502), and electric power is fed from the power source unit (500) to the camera unit (200) through the cable (502).

10. A method as claimed in claim 1, characterized by transferring images produced by the camera unit (200) to a data processing device (600); performing, in the data processing device (600), image processing operations on the images produced by the camera unit (200), and displaying the images visually.

11. A system for forming an image of an organ, the system comprising at least one optical radiation source (402 to 404) for illuminating an organ, and a hand-held camera unit (200) comprising a camera (406, 416) for forming an image in an electronic form of an organ illuminated by at least one optical radiation source (402 to 404), characterized in that the camera unit (200) comprises
at least one exit aperture (412 to 414) via which the radiation of the optical radiation source (402 to 404) is emitted toward the organ, and at least one entrance aperture (410) via which the optical radiation supplied from the organ is received by the camera unit (200), each exit aperture (412 to 414) and entrance aperture (410) being separate apertures with respect to each other whose optical axes differ from each other.

12. A system as claimed in claim 11, characterized in that the optical axes of the exit apertures (412 to 414) and the entrance apertures (410) are parallel and unidirectional.

13. A system as claimed in claim 11, characterized in that the camera unit (200) comprises a nose part (408, 480, 490) which, while forming an image of the organ, is brought close to the organ of which an image is to be formed, the nose part (408, 480, 490) comprising at least one exit aperture (412 to 414) and entrance aperture (410).

14. A system as claimed in claim 11, characterized in that the organ of which an image is to be formed is an eye (202); the camera unit (200) is arranged to direct the optical radiation at only a portion of the pupil (302) in accordance with the optical axis of each exit aperture (412 to 414); the camera unit (200) is arranged to form an image of the eye over the portion (308) of the pupil (302) at which no optical radiation is directed, according to the optical axis of each entrance aperture (410).

15. A system as claimed in claim 14, characterized in that the system comprises an infrared radiation source (402) and a visible light radiation source (404); the camera unit (200) is arranged to illuminate the eye such that a radiation pattern (304) of the infrared radiation is directed at the pupil (302) of the eye symmetrically with respect to a radiation pattern (306) of the visible light.

16. A system as claimed in claim 14, characterized in that the camera unit (200) is arranged to focus the optical radiation onto the surface of the eye.

17. A system as claimed in claim 11, characterized in that the organ of which an image is to be formed is an ear; the camera unit (200) comprises a nose part (480) suitable for examining the ear, arranged to disperse the optical radiation directed at the area of which an image is to be formed such that the optical radiation has an even power distribution.

18. A system as claimed in claim 11, characterized in that the organ of which an image is to be formed is skin; the camera unit (200) is arranged to direct the optical radiation at the area of which an image is to be formed.

19. A system as claimed in claim 11, characterized in that the system further comprises a power source unit (500) and a cable (502) to interconnect the camera unit (200) and the power source unit (500); the power source unit (500) is arranged to feed electric power to the camera unit (200) through the cable (502).

20. A system as claimed in claim 11, characterized in that the system also comprises a data processing device (600) to which the camera unit (200) is arranged to transfer images it has produced; an image processing device (600) is arranged to perform image processing operations on the images of the camera unit (200), and to display the images visually.
